(19) United States
(12) Patent Application Publication
(10) Pub. No.: US 2006/0257605 A1
(43) Pub. Date: Nov. 16, 2006

(54) Shaft for Tools, A Tool and a Method of Fabrication Thereof

(76) Inventors: Germain Belanger, St-Germain (CA); Andre Fortier, Berthier-Sur-Mer (CA)

Correspondence Address: HOLLAND & BONZAGNI, P.C., 171 DWIGHT ROAD, SUITE 302, LONGMEADOW, MA, 01106-1700, US

(21) Appl. No.: 11/382,117

(22) Filed: May 8, 2006

(30) Foreign Application Priority Data
May 10, 2005 (CA) 2,506,986

(51) Int. Cl. B32B 27/02; B32B 5/02; B29D 23/00; B32B 1/08

(52) U.S. Cl. 428/36.4; 442/169; 442/172; 442/103; 428/36.9

(57) ABSTRACT

A shaft and a method of fabricating a shaft for a tool, comprising on at least part of a surface thereof at least one structural sheet comprising at least one of: i) glass fibers, ii) carbon fibers, iii) Kevlar™ fibers and polyester fibers, impregnated with one of: i) a thermoset resin and ii) a thermoplastic resin.

### CROSS REFERENCE TO RELATED APPLICATIONS

This application claims priority on Canadian application no. 2,506,986, filed on May 10, 2005. All documents above are herein incorporated by reference.

### FIELD OF THE INVENTION

The present invention relates to tools. More specifically, the present invention is concerned with shafts for tools.

### BACKGROUND OF THE INVENTION

A variety of tools in the field of farming, gardening or hammer tools comprise a shaft, which is made in wood, aluminium or fiberglass for example. Depending of a specific use of the tools, the shafts have a determined geometry, they are provided with a surface coating for improved grip or with a weather resistant coating, and a handle thereof may be ergonomically designed.

Different tools need shafts having different properties. For example, a shaft for a hammer tool needs to withstand impact forces; rakes, weeding hoes, shovels and forks are to withstand flexion; scrapers and augers need to resist compression and torsion respectively. As a consequence of their respective use, shafts of these tools each suffer from specific damages, as follows for example:
hammer tools shaft usually break under an impact in a plane interfacing the shaft and the remaining of the tool;
shovels like tools shaft typically break under cantilevered flexion strain;
rakes like tools shaft is mainly damaged by weathering; and
traction tools shaft generally escapes from the user's hands grip as a result of a cylindrical profile thereof.

Shafts for these tools have been increasingly adapted to each user's needs, by adding functions and features thereto, which in turn has resulted in increasingly complex and lengthy fabrication methods for these shafts.

Wood has long been a favorite material, in spite of the variability of this material as a rough material (knots, cracks etc . . . ) and of the produced end products due to its organic nature. Aluminium has been used, but the extrusion process may limit geometry of the shaft lengthwise.

Efforts have been made to provide shafts for tools able to combine a number of characteristic, according to a target use of the tool, such as the following:
structural features: as measured in terms of tension, flexion, compression, thrust and energy absorption; reduction of interface joints; increased dimensional stability;
ergonomic features: related to positioning of hand of the user, for example;
gripping features: related to an effective hold of the user's hands, during torsion, traction or thrust efforts;
wear resistance features;
service time with constant performances; and
aesthetical features, including texture and coloration.

There is still a need in the art for improved shafts.

### SUMMARY OF THE INVENTION

More specifically, there is provided a shaft for a tool, comprising on at least part of a surface thereof at least one structural sheet comprising at least one of: i) glass fibers, ii) carbon fibers, iii) Kevlar™ fibers and polyester fibers, impregnated with one of: i) a thermoset resin and ii) a thermoplastic resin.

There is further provided a method of fabricating a shaft, comprising applying over at least part of a pre-existing shaft at least one surface coating; and solidifying the surface coating, to yield a seamless structurally reinforced shaft.

Other objects, advantages and features of the present invention will become more apparent upon reading of the following non- restrictive description of embodiments thereof, given by way of example only with reference to the accompanying drawings.

### BRIEF DESCRIPTION OF THE DRAWINGS

In the appended drawings:

FIG. 1 is a side view of part of a shaft according to an embodiment of the present invention;

FIG. 2 is a side view of part of a shaft according to another embodiment of the present invention;

FIG. 3 is a side view of part of a shaft according to a further embodiment of the present invention;

FIG. 4 is a side view of part of a shaft according to still another embodiment of the present invention; and

FIGS. 5 show side views of parts of a shaft according to an embodiment of the present invention a) in a gripping part thereof; and b) in a central part thereof.

### DESCRIPTION OF EMBODIMENTS OF THE INVENTION

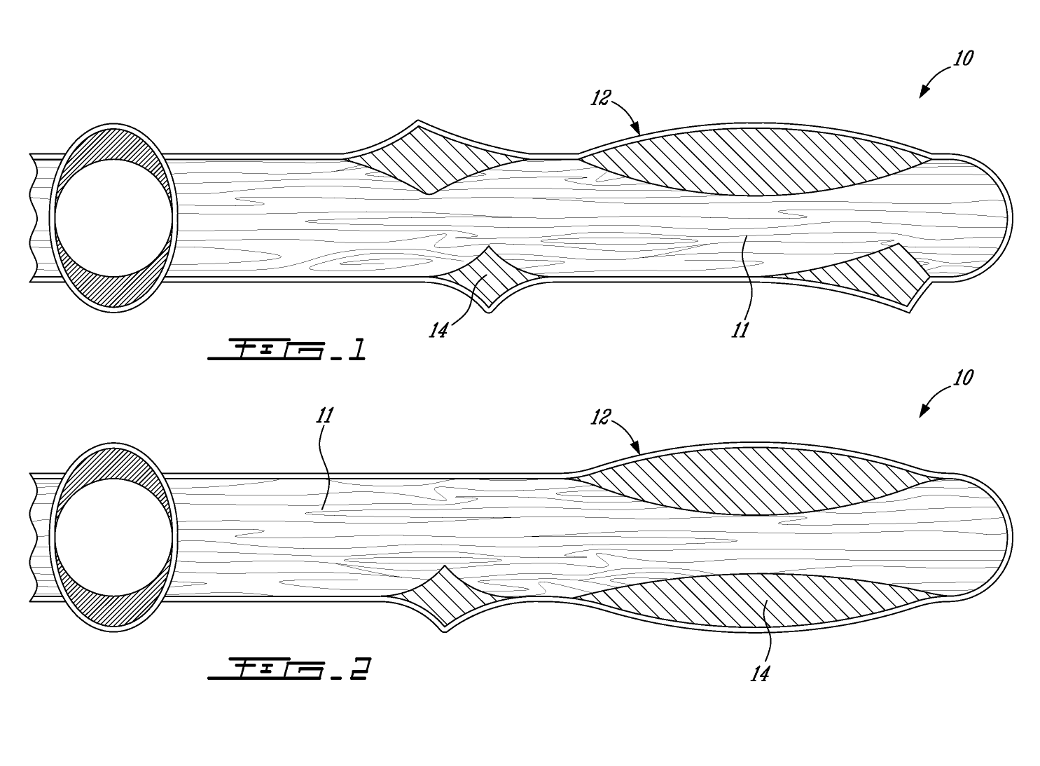

As illustrated in FIGS. 1 to 5 of the appended drawings, the shaft 10 comprises on at least part of a surface thereof a structural coating under the form of a sheath 12.

The sheath 12 may be solidified over the surface of a core 11 of the shaft 10, or the sheath 12 may be blown into a hollow shaft.

The sheath 12 may enclose inserts 14 provided on the core 11 of the shaft 10, thereby providing solidified regions of variable profile and cross section to yield varying cross sections and ergonomic features along the length of the shaft.

The core 11 may have a range of cross sections, including circular, oval or rectangular cross sections for example, and may be made of wood or aluminium for example.

The inserts 14 enclosed by the sheath 12 may comprise energy absorption material such as balsa or foam for example, or other materials selected depending on target properties, as will be described hereinbelow. Interestingly, such inserts 14 may allow adding localised structural properties to a given shaft that would be otherwise discarded as failing to meet target requirements.

The sheath 12 is a fiber coating impregnated with resin, comprising continuous filaments woven at an angle between 30 and 60 degrees in relation to a longitudinal axis of the shaft for example. This woven sheath contours the surface of the shaft, and fits thereto even in region of buried in features or protuberances for example, thereby providing a seamless continuous structural composite coating over the surface of the shaft, whatever the variations of cross-section of the shaft along the length thereof, yielding a one-piece shaft.

The structural coating may comprise a plurality of sheaths 12, including for example a first sheath covering the length of the shaft and a second sheath applied only on selected regions of the length of the shaft to provide target properties.

The fiber sheath may also be blown into a hollow shaft to yield a shaft with target properties.

A method for fabricating a shaft of the present invention comprises providing a shaft, or a tool; applying over at least part of the shaft, or over the tool, at least one surface coating; and solidifying the surface coating, to yield a seamless structurally reinforced shaft, or tool. The surface coating is a sheath of fibers, such as carbon, Kevlar™ or polyester fibers for example, impregnated with a thermoset resin such as epoxy, urethane, and polyester for example, or with a thermoplastic resin such as polypropylene, nylon, and polyester teraphtalate for example, depending on the process used for fabricating and applying the surface coating.

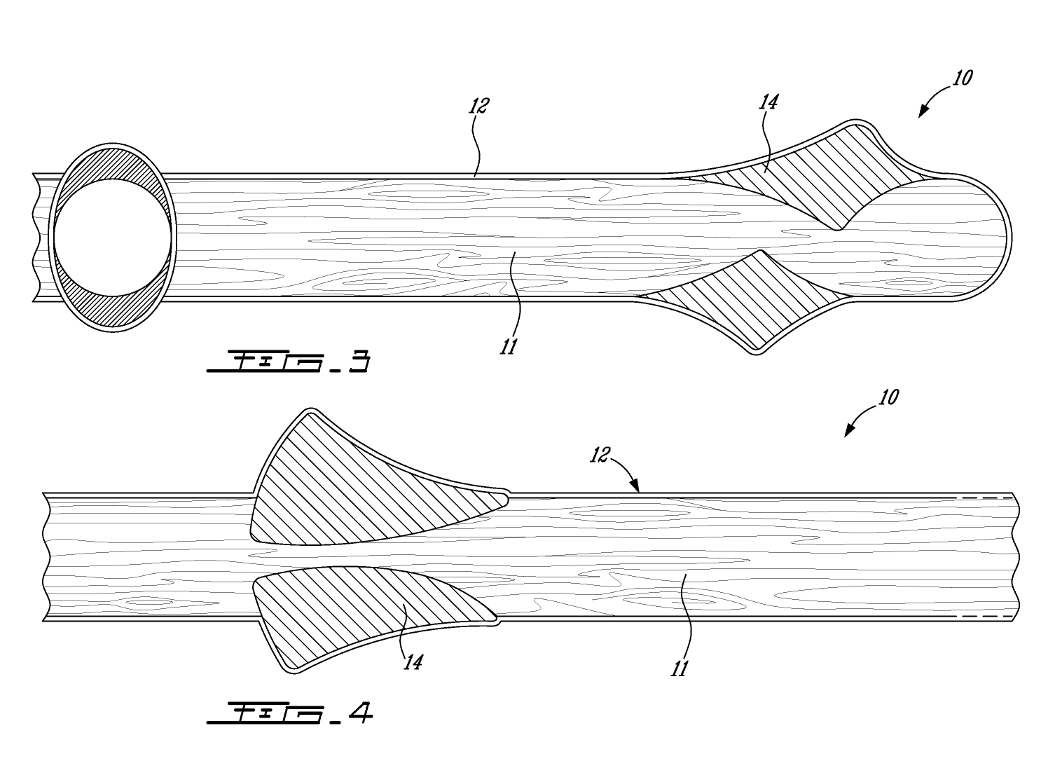

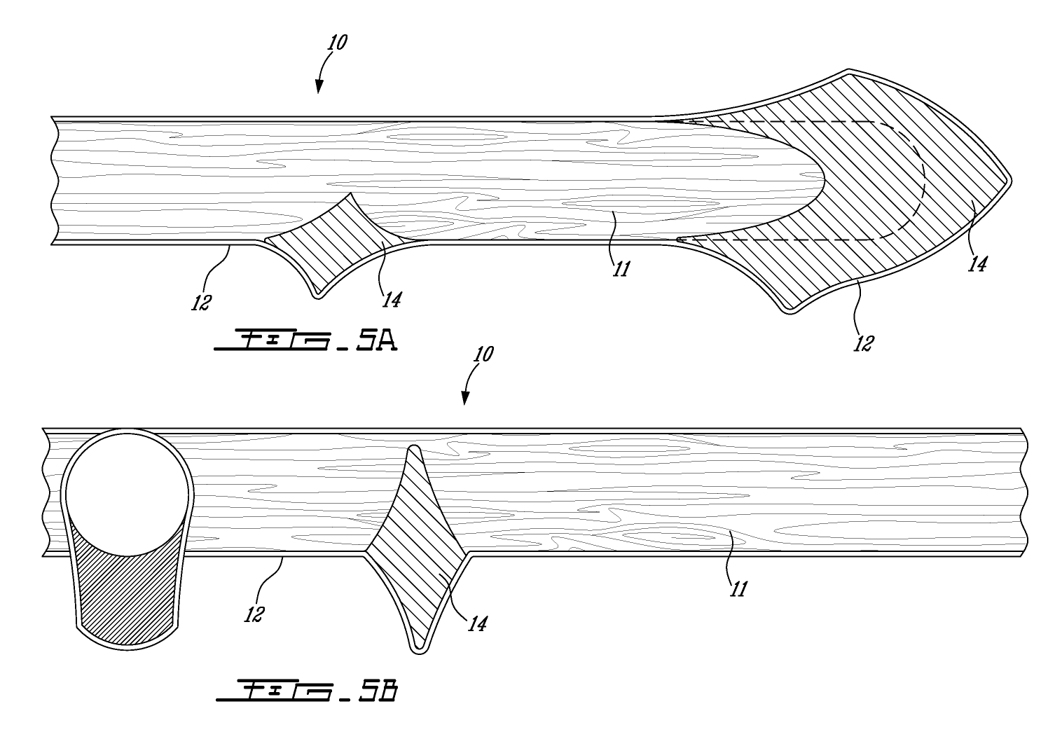

The resulting shaft or tool has improved properties in tension, flexion, resistance to impact and compression. The surface of the shaft or of the tool may thus be provided with a texture increasing gripping properties thereof, and/or of aesthetic purposes (see FIGS. 6-8). The sheath may allow incorporating ergonomic handles or protuberances (see FIGS. 4 and 5 for example) and energy absorption inserts comprising viscoelastic material (see FIG. 2 for example), for example.

Instead of such an overmolded sheath on a pre-existing shaft or tool, it may be contemplated solidifying such a sheath blown to a target shape for example, in absence of a core, to yield a hollow shaft or tool with selected and located structural properties.

People in the art will appreciate that the present invention provides a shaft and a method of fabrication therefore, which combines efficiency and cost-efficiency, for a range of tools including hammer tools, shovels like tools, rakes like tools and traction tools for example.

The present invention further allows making one-piece tools having a shaft in wood or aluminium for example, which alleviates the problems of the prior art, in terms of properties in tension, flexion, resistance to impact, compression and of surface finish for example.

Although the present invention has been described hereinabove by way of embodiments thereof, it may be modified, without departing from the nature and teachings of the subject invention as defined in the appended claims.

What is claimed is:

1. A shaft for a tool, comprising on at least part of a surface thereof at least one structural sheet comprising at least one of: i) glass fibers, ii) carbon fibers, iii) Kevlar™ fibers and polyester fibers, impregnated with one of: i) a thermoset resin and ii) a thermoplastic resin.

2. The shaft as claim 1, said shaft comprising a core, said sheet being solidified over at least part of a surface of said core.

3. The shaft as of claim 1, wherein said sheet is blown into a hollow shaft forming said shaft.

4. The shaft as of claim 2, wherein said sheet encloses inserts provided on the core.

5. The shaft as of claim 2, wherein said core has a cross section selected between including circular, oval and rectangular.

6. The shaft as of claim 2, wherein said core is made of one of wood, aluminium and fibers.

7. The shaft as of claim 4, wherein said inserts comprise energy absorption material.

8. The shaft as of claim 1, wherein said sheet is a fiber coating impregnated with resin, comprising continuous filaments woven at an angle between 30 and 60 degrees in relation to a longitudinal axis of the shaft.

9. A method of fabricating a shaft, comprising applying over at least part of a pre-existing shaft at least one surface coating; and solidifying the surface coating, to yield a seamless structurally reinforced shaft.

10. The method as of claim 9, wherein the surface coating is a sheath of fibers impregnated with a resin.

11. The method as of claim 9, further comprising the step of enclosing inserts between the pre-existing shaft and the surface coating.

12. The method as of claim 10, the inserts being ones of handles, protuberances and energy absorption inserts.

13. The method as of claim 9, wherein the pre-existing shaft is made in one of wood, aluminium and glass fibers, the surface coating comprising at least one of: i) glass fibers, carbon fibers, iii) Kevlar™ fibers and polyester fibers, impregnated with one of: i) a thermoset resin and ii) a thermoplastic resin.
